(19) United States
(12) Patent Application Publication
(10) Pub. No.: US 2024/0161961 A1
(43) Pub. Date: May 16, 2024

(54) REACTOR, CONVERTER, POWER CONVERSION DEVICE, AND METHOD FOR MANUFACTURING REACTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Naotoshi FURUKAWA, Mie (JP)

(21) Appl. No.: 18/283,580

(22) PCT Filed: Mar. 10, 2022
(86) PCT No.: PCT/JP2022/010628

§ 371 Date: Sep. 22, 2023

(30) Foreign Application Priority Data
Mar. 30, 2021 (JP) 2021-057588

(51) Int. Cl. H01F 27/255; H01F 27/28; H01F 27/30; H01F 41/02

(52) U.S. Cl. CPC H01F 27/255; H01F 27/2823; H01F 27/306; H01F 41/0246

(57) ABSTRACT

A reactor is provided in which: a coil includes one winding portion; a magnetic core includes a first core piece and a second core piece combined with each other; at least either the first core piece or the second core piece is constituted by a molded body of a composite material in which a soft magnetic powder is dispersed in a resin; the magnetic core includes a middle core portion, two side core portions, and two end core portions, in a state where the first core piece and the second core piece are combined; the middle core portion includes a portion arranged inside the winding portion; and the elastic body is provided in such a manner as to divide the middle core portion at an intermediate point or divide at least one of boundaries between the middle core portion and the end core portions.

### TECHNICAL FIELD

The present disclosure relates to a reactor, a converter, a power conversion device, and a reactor manufacturing method.

This application is based upon and claims the benefit of priority from Japanese Patent Application No. 2021-057588 filed in Japan on Mar. 30, 2021, the entire content of which is hereby incorporated by reference.

### BACKGROUND

Patent Document 1 discloses a reactor that includes a coil, a magnetic core, and a resin molded portion. The magnetic core is formed by combining a plurality of core pieces and a gap member. The resin molded portion integrates the coil and the magnetic core with each other. The resin molded portion is formed by injection molding. Specifically, the resin molded portion is formed by placing an assembly of the coil and the magnetic core in a mold, filling the mold with an unsolidified constituent resin for the resin molded portion, and then allowing the unsolidified constituent resin to solidify. A gap corresponding to the thickness of the gap member is formed in the mold between the core pieces of the magnetic core. The gap member is formed by allowing the unsolidified constituent resin to flow into the gap formed between the core pieces and then allowing the constituent resin to solidify. Hereinafter, the resin molded portion will be referred to as a molded resin portion.

### PRIOR ART DOCUMENT

### Patent Document

Patent Document 1: JP 2016-171136 A

### SUMMARY OF THE INVENTION

A reactor according to an aspect of the present disclosure includes: a coil; a magnetic core; a molded resin portion; and an elastic body, wherein the coil includes one winding portion, the magnetic core includes a first core piece and a second core piece combined with each other, at least either the first core piece or the second core piece is constituted by a molded body of a composite material in which a soft magnetic powder is dispersed in a resin, the magnetic core includes a middle core portion, two side core portions, and two end core portions, in a state where the first core piece and the second core piece are combined, the middle core portion includes a portion arranged inside the winding portion, the two side core portions are arranged side by side with the middle core portion on outward sides of the winding portion, the two end core portions are arranged in such a manner as to connect the middle core portion to the two side core portions on outward sides of end portions of the winding portion, the molded resin portion covers at least part of the magnetic core, and the elastic body is provided in such a manner as to divide the middle core portion at an intermediate point or divide at least one of boundaries between the middle core portion and the end core portions.

A converter according to an aspect of the present disclosure includes the reactor according to an aspect of the present disclosure.

A power conversion device according to an aspect of the present disclosure includes the converter according to an aspect of the present disclosure.

A reactor manufacturing method according to an aspect of the present disclosure includes the steps of: preparing an assembly including a coil, a magnetic core, and an elastic body; and forming a molded resin portion in such a manner as to cover at least part of the magnetic core, by arranging the assembly in a mold and injecting a resin into the mold, wherein the coil includes one winding portion, the magnetic core includes a first core piece and a second core piece combined with each other, at least either the first core piece or the second core piece is constituted by a molded body of a composite material in which a soft magnetic powder is dispersed in a resin, the magnetic core includes a middle core portion, two side core portions, and two end core portions, in a state where the first core piece and the second core piece are combined, the middle core portion includes a portion arranged inside the winding portion, the two side core portions are arranged side by side with the middle core portion on outward sides of the winding portion, the two end core portions are arranged in such a manner as to connect the middle core portion to the two side core portions on outward sides of end portions of the winding portion, in the preparing of the assembly, the elastic body is arranged in such a manner as to divide the middle core portion at an intermediate point or divide at least one of boundaries between the middle core portion and the end core portions, and in the forming of the molded resin portion, a pressure of 15 MPa or more is applied in a direction according to which the two end core portions approach each other.

### BRIEF DESCRIPTION OF THE DRAWINGS

FIG. 1 is a cross-sectional view showing an overview of a reactor according to a first embodiment.

FIG. 2 is a schematic diagram showing the flow of magnetic flux in a magnetic core of the reactor of FIG. 1.

FIG. 3 is an illustrative diagram for describing a first area ratio of an elastic body after compression.

FIG. 4 is an illustrative diagram for describing a second area ratio of the elastic body after compression.

FIG. 5 is an illustrative diagram for describing a molding step in a reactor manufacturing method according to the first embodiment.

FIG. 6 is an illustrative diagram for describing the first area ratio of the elastic body before compression.

FIG. 7 is an illustrative diagram for describing the second area ratio of the elastic body before compression.

FIG. 8 is a cross-sectional view showing an overview of a reactor according to a second embodiment.

FIG. 9 is a cross-sectional view showing an overview of a reactor according to a third embodiment.

FIG. 10 is a cross-sectional view showing an overview of a reactor according to a fourth embodiment.

FIG. 11 is a cross-sectional view showing an overview of a reactor according to a fifth embodiment.

FIG. 12 is a configuration diagram schematically showing a power supply system of a hybrid vehicle.

FIG. 13 is a circuit diagram showing an overview of an example of a power conversion device that includes a converter.

### DETAILED DESCRIPTION TO EXECUTE THE INVENTION

### Problems to be Solved

In the case where the molded resin portion is formed by injection molding, depending on the shape of the magnetic core, there is a risk that cracks may be formed in the magnetic core due to pressure applied during injection molding. For this reason, depending on the shape of the magnetic core, a constraint regarding pressure is provided during injection molding, for example.

One object of the present disclosure is to provide a reactor according to which few cracks are formed in the magnetic core. Another object of the present disclosure is to provide a converter that includes such a reactor. Yet another object of the present disclosure is to provide a power conversion device that includes such a converter. Still another object of the present disclosure is to provide a reactor manufacturing method in which cracks are unlikely to be formed in the magnetic core even when high pressure is applied in the manufacturing process.

### Advantageous Effects of Present Disclosure

With the reactor according to an aspect of the present disclosure, few cracks are formed in the magnetic core. With the converter according to an aspect of the present disclosure and the power conversion device according to an aspect of the present disclosure, few cracks are formed in the magnetic core. In the reactor manufacturing method according to an aspect of the present disclosure, cracks are unlikely to be formed in the magnetic core even when high pressure is applied in the manufacturing process.

### DESCRIPTION OF EMBODIMENTS OF PRESENT DISCLOSURE

First, embodiments of the present disclosure will be listed and described.
(1) A reactor according to an aspect of the present disclosure includes: a coil; a magnetic core; a molded resin portion; and an elastic body, wherein the coil includes one winding portion, the magnetic core includes a first core piece and a second core piece combined with each other, at least either the first core piece or the second core piece is constituted by a molded body of a composite material in which a soft magnetic powder is dispersed in a resin, the magnetic core includes a middle core portion, two side core portions, and two end core portions, in a state where the first core piece and the second core piece are combined, the middle core portion includes a portion arranged inside the winding portion, the two side core portions are arranged side by side with the middle core portion on outward sides of the winding portion, the two end core portions are arranged in such a manner as to connect the middle core portion to the two side core portions on outward sides of end portions of the winding portion, the molded resin portion covers at least part of the magnetic core, and the elastic body is provided in such a manner as to divide the middle core portion at an intermediate point or divide at least one of boundaries between the middle core portion and the end core portions.

In the reactor according to this aspect of the present disclosure, the elastic body is provided at an intermediate point or an end portion of the middle core portion, and thus few cracks are formed in the magnetic core. The reactor according to this aspect of the present disclosure is obtained by a manufacturing method described below. Specifically, the reactor according to this aspect of the present disclosure is obtained by placing an assembly that includes a coil, a magnetic core, and an elastic body in a mold and injecting resin into the mold to form a molded resin portion. When forming the molded resin portion, pressure is applied in a direction according to which the two end core portions approach each other. In the reactor according to this aspect of the present disclosure, the elastic body is provided at an intermediate point or an end portion of the middle core portion that is likely to be influenced by the above-described pressure, and therefore the load applied due to the pressure can be absorbed by the elastic body in the manufacturing process, and cracks are unlikely to be formed in the magnetic core. Since cracks are unlikely to be formed in the magnetic core in the manufacturing process, few cracks are formed in the magnetic core of the obtained reactor according to this aspect of the present disclosure.

Generally, in order to maintain a predetermined inductance, the magnetic core is provided with a gap member in a core portion that has a portion arranged inside the winding portion. In the case where the magnetic core includes a middle core portion, two side core portions, and two end core portions as in the reactor according to this aspect of the present disclosure, the gap member is provided in the middle core portion. In the case where the gap member is molded using the constituent resin of the molded resin portion as in the technology described in Patent Document 1, the middle core portion is provided with a gap that is to be filled with unsolidified constituent resin of the molded resin portion in the reactor manufacturing process. If the gap is provided in the middle core portion, the two end portions of the end core portion are supported by the side core portions, but, due to the gap, the central portion of the end core portion is not supported and is in a floating state. When the unsolidified constituent resin is injected for molding in this state, a load is likely to act on the central portion of the end core portion with two end portions of the end core portion serving as fulcrums.

In the reactor according to this aspect of the present disclosure, an elastic body is used as the gap member, and therefore a predetermined inductance can be maintained, the load can be absorbed by the elastic body, and cracks are unlikely to be formed in the magnetic core. Using an elastic body as the gap member makes it possible to also anticipate an effect of facilitating adjustment of the gap length. The gap for arrangement of the elastic body is formed between the first core piece and the second core piece when the first core piece and the second core piece are combined. The gap length is the length of the gap along the axial direction of the middle core portion. The gap length is equivalent to the thickness of the elastic body in the compressed state.
(2) The reactor according to an aspect of the present disclosure may have a configuration in which the two side core portions and the two end core portions are continuous with each other.

In the configuration of aspect 2, an elastic body is not needed for the two side core portions and the two end core portions, the number of parts is small, and the reactor is excellent in terms of ease of assembly. Here, the phrase “continuous with each other” includes the following two aspects. The first aspect is an aspect in which all of the core portions are a single molded body that is at least a part of either the first core piece or the second core piece. For example, when looking at one of the side core portions, the side core portion is configured as a part of the first core piece or the second core piece. The second aspect is an aspect in which a core portion is constituted by two molded bodies divided as respective parts of the first core piece and the second core piece, but the divided parts of the core portion are in direct contact with each other without any intervening member. For example, when looking at one of the side core portions, one portion of the side core portion is constituted by the first core piece, and the remaining portion of the side core portion is constituted by the second core piece. When the first core piece and the second core piece have been combined, the portion of the side core portion constituted by the first core piece and the remaining portion of the side core portion constituted by the second core piece are in continuous direct contact with each other without any intervening member.
(3) The reactor according to an aspect of the present disclosure may have a configuration in which a ratio of the area of the elastic body to a predetermined area is 70% or more, the predetermined area being obtained by length A×length B, the length A being the length of the middle core portion along a direction orthogonal to both a lengthwise direction of the middle core portion and a direction in which the middle core portion and the two side core portions are side by side, the length B being a distance between inward faces of the two side core portions, and the area of the elastic body being the area of a face of the elastic body facing the middle core portion when the elastic body is in a compressed state.

The length B corresponds to the inter-fulcrum distance between the fulcrums supported by the side core portions at two end portions of the end core portion. The predetermined area is the area of a region that is likely to be subjected to pressure applied when forming the molded resin portion in the reactor manufacturing process. Bending force is likely to act on the fulcrums in this region. Since the elastic body is provided in a certain range of the predetermined area, the load applied to the middle core portion is likely to be absorbed by the elastic body, and cracks are even more unlikely to be formed in the magnetic core. Since cracks are even more unlikely to be formed in the magnetic core in the manufacturing process, the obtained reactor according to this aspect of the present disclosure has fewer cracks in the magnetic core.
(4) The reactor according to an aspect of the present disclosure may have a configuration in which a ratio of the area of the elastic body to a cross-sectional area of the middle core portion is 70% or more, the cross-sectional area of the middle core portion being the area of a cross-section of the middle core portion taken along a direction orthogonal to a lengthwise direction of the middle core portion, and the area of the elastic body being the area of a face of the elastic body facing the middle core portion when the elastic body is in a compressed state.

Since the elastic body is provided in a certain range of the cross-sectional area of the middle core portion, the load applied to the middle core portion is likely to be absorbed by the elastic body, and cracks are even more unlikely to be formed in the magnetic core. Since cracks are even more unlikely to be formed in the magnetic core in the manufacturing process, the obtained reactor according to this aspect of the present disclosure has fewer cracks in the magnetic core.
(5) The reactor according to an aspect of the present disclosure may have a configuration in which the elastic body is made of silicone rubber or butyl rubber.

In the configuration of aspect 5, the load applied to the middle core portion is likely to be absorbed by the elastic body, and cracks are even more unlikely to be formed in the magnetic core. Since cracks are even more unlikely to be formed in the magnetic core in the manufacturing process, the obtained reactor according to this aspect of the present disclosure has fewer cracks in the magnetic core.
(6) The reactor according to an aspect of the present disclosure may have a configuration in which the first core piece and the second core piece are each an E-shaped member including one of the two end core portions, a portion of the middle core portion, and a portion of each of the two side core portions.

In the configuration of aspect 6, the middle core portion is divided into the first core piece and the second core piece, and therefore the elastic body can be easily provided at an intermediate point in the middle core portion. According to the configuration of aspect 6, the two core pieces can be manufactured using the same mold, and it is possible to improve reactor productivity.
(7) The reactor according to an aspect of the present disclosure may have a configuration in which the first core piece is an E-shaped member including one of the two end core portions, a portion of the middle core portion, and each of the two side core portions, and the second core piece is a T-shaped member including another one of the two end core portions, and a remaining portion of the middle core portion.

In the configuration of aspect 7, the middle core portion is divided into the first core piece and the second core piece, and therefore the elastic body can be easily provided at an intermediate point in the middle core portion.
(8) The reactor according to an aspect of the present disclosure may have a configuration in which the first core piece is an E-shaped member including one of the two end core portions, the middle core portion, and each of the two side core portions, and the second core piece is an I-shaped member including another one of the two end core portions.

In the configuration of aspect 8, the elastic body can be easily provided between one end portion of the middle core portion of the first core piece and the second core piece (i.e., the end core portion).
(9) The reactor according to an aspect of the present disclosure may have a configuration in which the first core piece is an E-shaped member including one of the two end core portions, the middle core portion, and a portion of each of the two side core portions, and the second core piece is a U-shaped member including another one of the two end core portions, and a remaining portion of each of the two side core portions.

In the configuration of aspect 9, the elastic body can be easily provided between one end portion of the middle core portion of the first core piece and the end core portion of the second core piece.
(10) The reactor according to an aspect of the present disclosure may have a configuration in which the first core piece is an O-shaped member including each of the two end core portions and each of the two side core portions, and the second core piece is an I-shaped member including the middle core portion.

In the configuration of aspect 10, the elastic body can be easily provided between at least one end portion of the second core piece (i.e., the middle core portion) and an end core portion of the first core piece.
(11) A converter according to an aspect of the present disclosure includes the reactor according to any one of aspects 1 to 10.

Due to including the reactor according to an aspect of the present disclosure, few cracks are formed in the magnetic core of the converter according to this aspect of the present disclosure.
(12) A power conversion device according to an aspect of the present disclosure includes the converter according to aspect 11.

Due to including the converter according to an aspect of the present disclosure, few cracks are formed in the magnetic core of the power conversion device according to this aspect of the present disclosure.
(13) A reactor manufacturing method according to an aspect of the present disclosure includes the steps of: preparing an assembly including a coil, a magnetic core, and an elastic body; and forming a molded resin portion in such a manner as to cover at least part of the magnetic core, by arranging the assembly in a mold and injecting a resin into the mold, wherein the coil includes one winding portion, the magnetic core includes a first core piece and a second core piece combined with each other, at least either the first core piece or the second core piece is constituted by a molded body of a composite material in which a soft magnetic powder is dispersed in a resin, the magnetic core includes a middle core portion, two side core portions, and two end core portions, in a state where the first core piece and the second core piece are combined, the middle core portion includes a portion arranged inside the winding portion, the two side core portions are arranged side by side with the middle core portion on outward sides of the winding portion, the two end core portions are arranged in such a manner as to connect the middle core portion to the two side core portions on outward sides of end portions of the winding portion, in the preparing of the assembly, the elastic body is arranged in such a manner as to divide the middle core portion at an intermediate point or divide at least one of boundaries between the middle core portion and the end core portions, and in the forming of the molded resin portion, a pressure of 15 MPa or more is applied in a direction according to which the two end core portions approach each other.

With the reactor manufacturing method according to this aspect of the present disclosure, even when a high pressure of 15 MPa or more is applied when forming the molded resin portion, cracks are unlikely to be formed in the magnetic core. This is because, with the reactor manufacturing method according to this aspect of the present disclosure, the elastic body is provided at an intermediate point or the end portion of the middle core portion that is likely to be influenced by the above-described pressure, and therefore the load applied due to the pressure can be absorbed by the elastic body.

As described above, generally, in order to maintain a predetermined inductance, the magnetic core is provided with a gap member in a core portion that has a portion arranged inside the winding portion. In the case where the gap member is molded using the constituent resin of the molded resin portion as in the technology described in Patent Document 1, the middle core portion is provided with a gap that is to be filled with unsolidified constituent resin of the molded resin portion in the reactor manufacturing process. If the gap is provided in the middle core portion, the two end portions of the end core portion are supported by the side core portions, but, due to the gap, the central portion of the end core portion is not supported and is in a floating state. When the unsolidified constituent resin is injected for molding in this state, a load is likely to act on the central portion of the end core portion with two end portions of the end core portion serving as fulcrums.

With the reactor manufacturing method according to this aspect of the present disclosure, an elastic body is used as the gap member, and therefore a predetermined inductance can be maintained, the load can be absorbed by the elastic body, and cracks are unlikely to be formed in the magnetic core. Using an elastic body as the gap member makes it possible to also anticipate an effect of facilitating adjustment of the gap length.

(14) The reactor manufacturing method according to an aspect of the present disclosure may have a configuration in which in the preparing of the assembly, an elastic body in an uncompressed state is arranged, the elastic body in the uncompressed state having an area greater than or equal to 45% of a predetermined area, the predetermined area being obtained by length A×length B, the length A being the length of the middle core portion along a direction orthogonal to both a lengthwise direction of the middle core portion and a direction in which the middle core portion and the two side core portions are side by side, and the length B being a distance between inward faces of the two side core portions.

The length B corresponds to the inter-fulcrum distance between the fulcrums supported by the side core portions at two end portions of the end core portion. The predetermined area is the area of a region that is likely to be subjected to pressure applied when forming the molded resin portion. Bending force is likely to act on the fulcrums in this region. Since the elastic body is provided in a certain range of the predetermined area, the load applied to the middle core portion is likely to be absorbed by the elastic body, and cracks are even more unlikely to be formed in the magnetic core.

(15) The reactor manufacturing method according to an aspect of the present disclosure may have a configuration in which in the preparing of the assembly, an elastic body in an uncompressed state is arranged, the elastic body in the uncompressed state having an area greater than or equal to 75% and less than or equal to 95% of a cross-sectional area of the middle core portion, the cross-sectional area of the middle core portion being the area of a cross-section of the middle core portion taken along a direction orthogonal to a lengthwise direction of the middle core portion.

Since the elastic body is provided in a certain range of the cross-sectional area of the middle core portion, the load applied to the middle core portion is likely to be absorbed by the elastic body, and cracks are even more unlikely to be formed in the magnetic core. When a load is applied to the middle core portion, the elastic body becomes compressed. The compressed elastic body protrudes from the outer peripheral portion of the middle core portion. Due to providing the elastic body that has an area of 95% of the cross-sectional area of the middle core portion or less, it is possible to suppress excessive protrusion of the compressed elastic body from the outer peripheral portion of the middle core portion.

### DETAILS OF EMBODIMENTS OF PRESENT DISCLOSURE

Specific examples of reactors according to embodiments of the present disclosure will be described below with reference to the drawings. Like reference numerals in the drawings indicate elements having like names In the drawings, the configurations may be partially exaggerated or simplified for convenience in the description. The dimensional ratios of portions in the drawings may also differ from the actual ratios. Note that the present disclosure is not limited to these examples, but rather is indicated by the scope of the claims, and is intended to include all modifications within the scope and meaning equivalent to the scope of the claims.

### First Embodiment

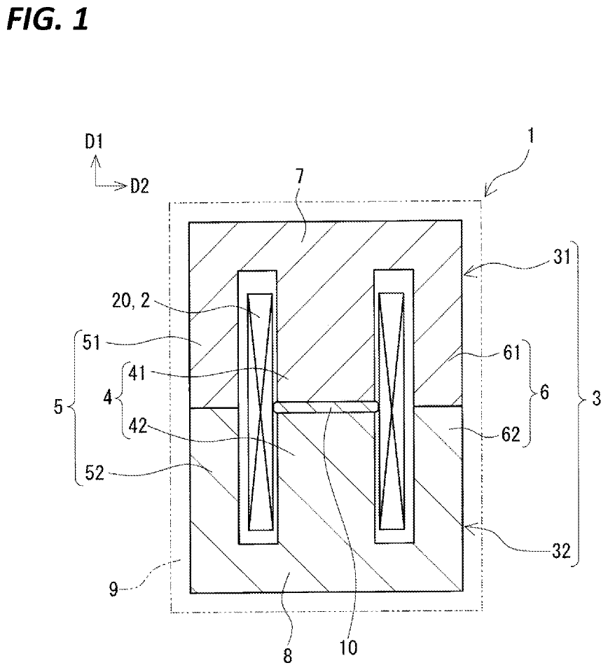

A reactor 1 according to a first embodiment will be described below with reference to FIGS. 1 to 7. The reactor 1 includes a coil 2, a magnetic core 3, and a molded resin portion 9. One feature of the reactor 1 of the first embodiment is that an elastic body 10 is provided so as to divide a middle core portion 4 of the magnetic core 3. The various configurations will be described in detail below.

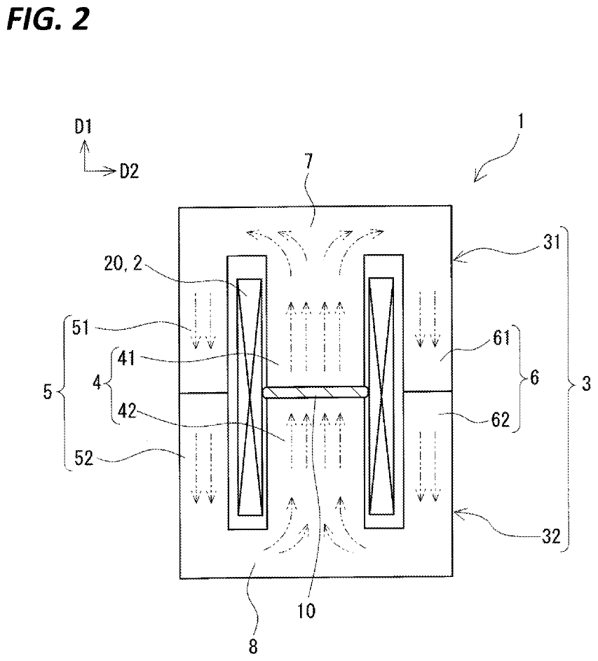

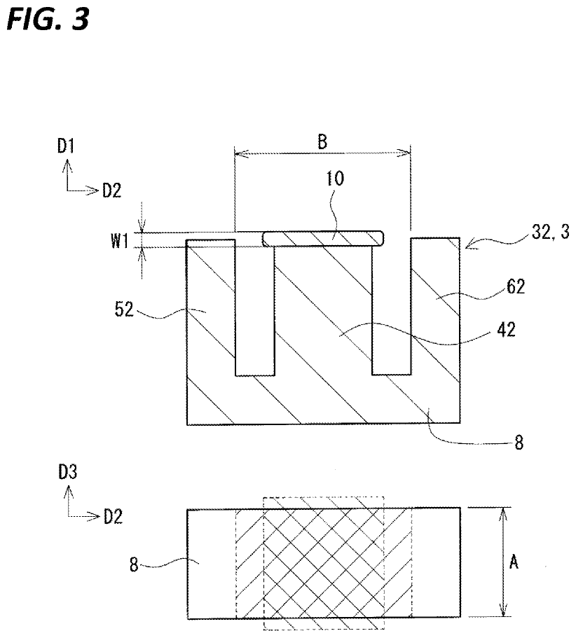

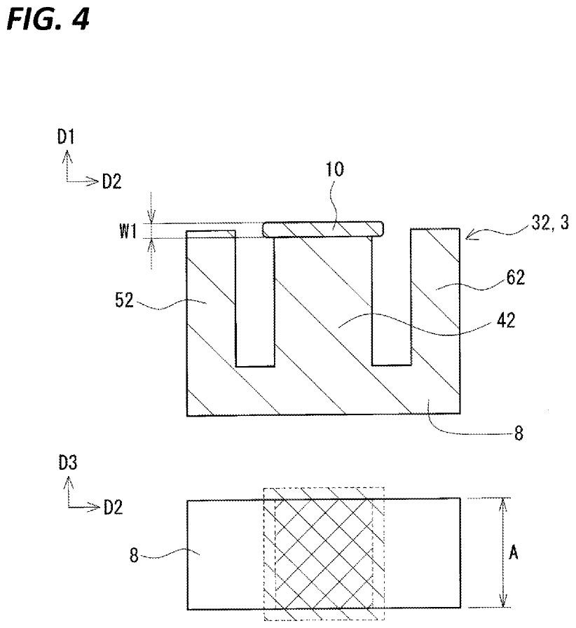

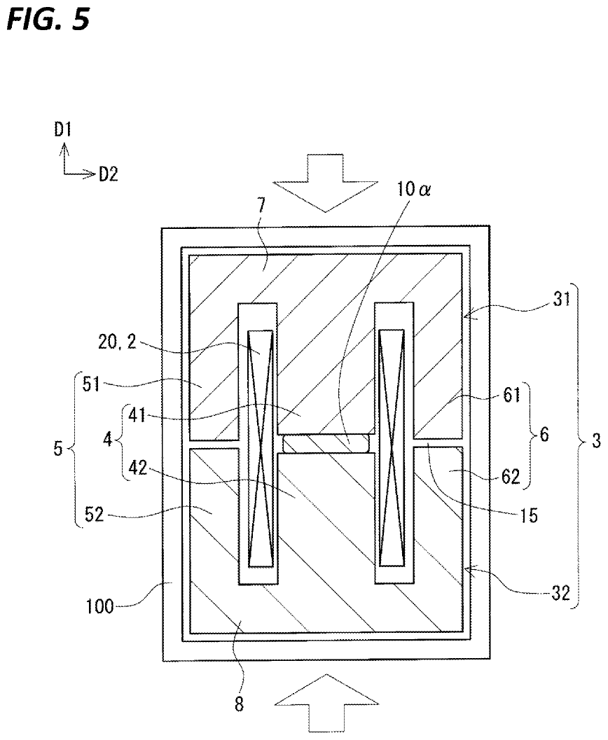

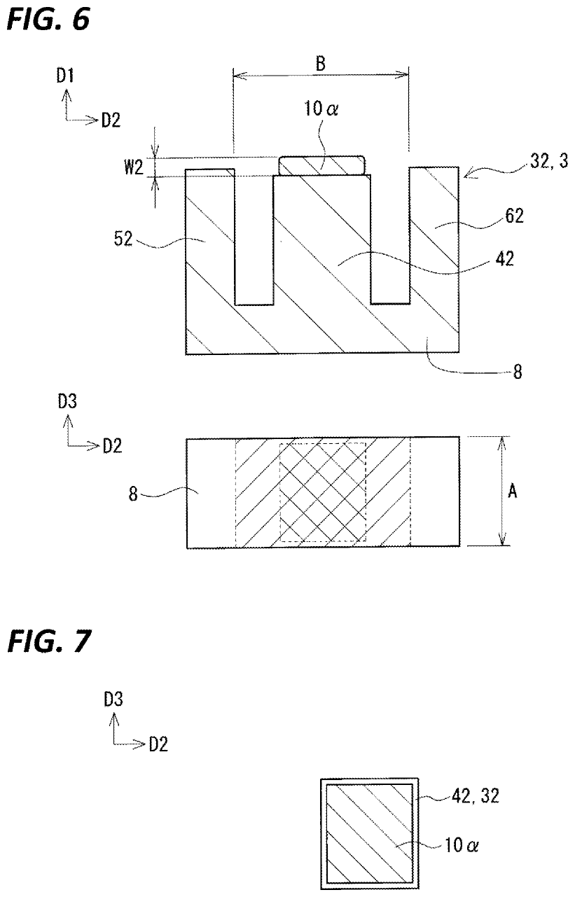

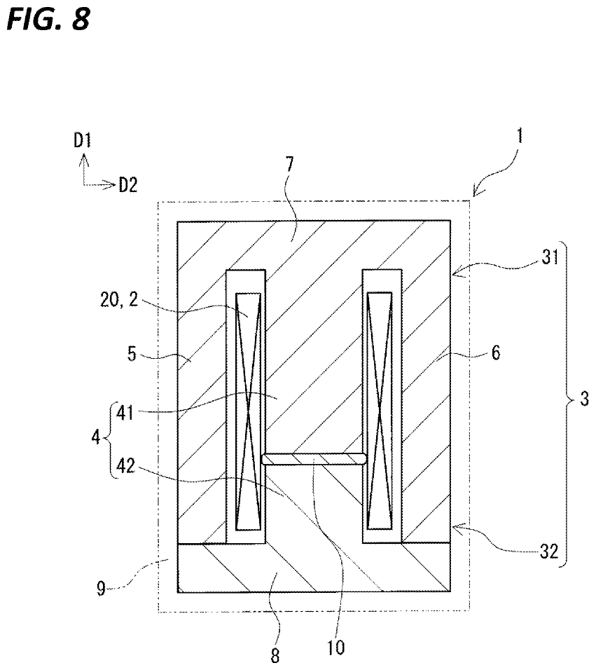

FIG. 1 shows an overview of the reactor 1. FIG. 1 is a cross-sectional view of the reactor 1 taken along a plane orthogonal to a third direction D3. FIGS. 8 to 11 are also cross-sectional views similar to FIG. 1. In FIG. 1, a dash double-dotted line indicates the outline of only the portion of the molded resin portion 9 provided around the magnetic core 3. In FIG. 2, the flow of magnetic flux in the magnetic core 3 of the reactor 1 of FIG. 1 is shown by dash double-dotted arrows. FIGS. 3 and 4 show only a second core piece 32 and the elastic body 10 of the reactor 1 of FIG. 1. The upper portions of FIGS. 3 and 4 show the second core piece 32 and the elastic body 10 as viewed from the third direction D3. The lower portions of FIGS. 3 and 4 show the second core piece 32 as viewed from outward in a first direction D1. The third direction D3 and the first direction D1 will be described later. The elastic body 10 shown in FIGS. 1 to 4 is in a compressed state. FIG. 5 shows a state in which an assembly including the coil 2, the magnetic core, and an elastic body 10α has been placed in a mold 100 in the process of manufacturing the reactor 1. FIGS. 6 and 7 show only the elastic body 10α and the second core piece 32 of the magnetic core 3 in the assembly. The elastic body 10α shown in FIGS. 5 to 7 is in an uncompressed state before being compressed during the manufacturing process.

### «Coil»

The coil 2 includes one winding portion 20, as shown in FIG. 1. The winding portion 20 is configured by winding a single coil wire into a spiral. The two ends of the coil wire are drawn out from the axial end portions of the winding portion 20. Terminal fittings (not shown) are attached to the two ends of the coil wire that were drawn out from the winding portion 20. An external device such as a power supply (not shown) is connected to the terminal fittings. Note that FIG. 1 and the like show only the winding portion 20, and the coil wire end portions and the like are not shown.

A coil wire is a coated wire that includes a conductor wire and an insulating coating, for example. The conductor wire is made of copper, for example. The insulating coating is made of a resin such as polyamide-imide, for example. The coated wire is a coated flat wire that has a rectangular cross-section, or a coated round wire that has a circular cross-section, for example.

The coil 2 of the present embodiment is a rectangular tubular edgewise coil obtained by a coated flat wire being wound edgewise. The end face of the winding portion 20 viewed from the axial direction thus has a rectangular shape. The rectangular shape may be a square shape. The winding portion 20 has four flat faces and four corner portions. The corner portions are rounded. The faces of the winding portion 20 outside the corner portions are substantially flat faces. It is therefore easy to secure a large area of contact between the winding portion 20 and the installation target. Since the area of contact is large, the winding portion 20 can be more easily held stably on the installation target. Also, since the area of contact is large, heat from the reactor 1 is easily dissipated to the installation target via the winding portion 20. The winding portion 20 may be a cylindrical coil.

### «Magnetic Core»

As shown in FIG. 1, the magnetic core 3 includes a first core piece 31 and a second core piece 32 that are combined with each other. The magnetic core 3 is overall shaped as the character “θ” when the first core piece 31 and the second core piece 32 are combined with each other. When the first core piece 31 and the second core piece 32 are combined with each other, the magnetic core 3 includes a middle core portion 4, two side core portions 5 and 6, and two end core portions 7 and 8. In the present embodiment, the first core piece 31 and the second core piece 32 are each an E-shaped member.

Hereinafter, the overall shape of the magnetic core 3 will be described first, and then the shapes of the first core piece 31 and the second core piece 32 that constitute the magnetic core 3 will be described. In the following description, the direction along the axial direction of the winding portion 20 is a first direction D1, the direction in which the one middle core portion 4 and the two side core portions 5 and 6 are side by side with each other is a second direction D2, and the direction orthogonal to both the first direction D1 and the second direction D2 is a third direction D3. Also, in the following description, the sides of the side core portions 5 and 6 that are farther from the winding portion 20 will be called the outer sides, and the sides of the side core portions 5 and 6 that are closer to the winding portion 20 will be called the inner sides. Similarly, the sides of the end core portions 7 and 8 that are farther from the winding portion 20 will be called the outer sides, and the sides of the end core portions 7 and 8 that are closer to the winding portion 20 will be called the inner sides.

### [Overall Shape of Magnetic Core]

The middle core portion 4 has a portion arranged inside the winding portion 20. The two side core portions 5 and 6 are arranged side by side with the middle core portion 4 on outward sides of the winding portion 20. The two end core portions 7 and 8 are arranged so as to connect the middle core portion 4 to the two side core portions 5 and 6 on outward sides of the end portions of the winding portion 20. Due to the middle core portion 4, the two side core portions 5 and 6, and the two end core portions 7 and 8 of the magnetic core 3 being connected to each other, when the coil 2 is excited, magnetic flux flows, and a closed magnetic circuit is formed. As shown by dash double-dotted arrows in FIG. 2, magnetic flux flows from the middle core portion 4 to the end core portion 7, flows from the end core portion 7 to each of the two side core portions 5 and 6, flows from the side core portions 5 and 6 to the end core portion 8, and flows from the end core portion 8 to the middle core portion 4.

### (Middle Core Portion)

The shape of the middle core portion 4 is a shape that approximately corresponds to the inner peripheral shape of the winding portion 20. In the present embodiment, the middle core portion 4 is shaped as a quadrangular prism, or more specifically a rectangular prism, and the end faces of the middle core portion 4 have a rectangular shape when viewed from the axial direction. The corner portions of the middle core portion 4 are rounded so as to extend along the corner portions of the winding portion 20. A gap exists between the outer peripheral surface of the middle core portion 4 and the inner peripheral surface of the winding portion 20. The molded resin portion 9, which will be described later, is formed in at least part of this gap.

As shown in FIG. 1, the middle core portion 4 of the present embodiment is constituted by a first middle core portion 41 and a second middle core portion 42. An elastic body 10, which will be described later, is provided between the first middle core portion 41 and the second middle core portion 42. In other words, the middle core portion 4 of the present embodiment is divided at an intermediate point by the elastic body 10.

The length of the middle core portion 4 along the first direction D1 is greater than or equivalent to the length of the winding portion 20 along the first direction D1. In the present embodiment, the length of the middle core portion 4 along the first direction D1 is slightly longer than the length of the winding portion 20 along the first direction D1, as shown in FIG. 1. The middle core portion 4 of the present embodiment includes a portion arranged inside the winding portion 20 and a portion arranged outside the winding portion 20. The two end portions of the middle core portion 4 are located outside the winding portion 20.

### (Side Core Portions)

There are no particular limitations on the shapes of the side core portion 5 and 6, as long as they extend along the first direction D1 at positions outside the winding portion 20. In the present embodiment, the side core portions 5 and 6 are each shaped as a rectangular parallelepiped that is elongated along the first direction D1. The side core portions 5 and 6 are arranged so as to sandwich the winding portion 20 from the outside. In the case where the winding portion 20 is a rectangular tubular edgewise coil, the side core portions 5 and 6 are arranged so as to face two surfaces that face each other among the four surfaces forming the outer peripheral surface of the winding portion 20. The surfaces of the winding portion 20 that do not face the side core portions 5 and 6 are exposed from the magnetic core 3.

As shown in FIG. 1, the side core portion 5 of the present embodiment is constituted by a first side core portion 51 and a second side core portion 52. The first side core portion 51 and the second side core portion 52 are in direct contact with each other so as to be continuous and unseparated. In other words, no gap or gap member is arranged between the first side core portion 51 and the second side core portion 52.

Similarly to the side core portion 5, the side core portion 6 of the present embodiment is constituted by a first side core portion 61 and a second side core portion 62. The first side core portion 61 and the second side core portion 62 are in direct contact with each other so as to be continuous and unseparated. In other words, no gap or gap member is arranged between the first side core portion 51 and the second side core portion 52.

In the present embodiment, the two side core portions 5 and 6 have the same shape and dimensions. The length of each of the side core portions 5 and 6 along the first direction D1 is longer than the length of the middle core portion 4 along the first direction D1. In the present embodiment, the length of each of the side core portions 5 and 6 along the second direction D2 is shorter than the length of the middle core portion 4 along the second direction D2. In the present embodiment, the sum of the length of the side core portion 5 along the second direction D2 and the length of the side core portion 6 along the second direction D2 is shorter than the length of the middle core portion 4 along the second direction D2. In the present embodiment, the length of each of the side core portions 5 and 6 along the third direction D3 is the same as the length of the middle core portion 4 along the third direction D3. The sum of the lengths of the side core portions 5 and 6 along the second direction D2 may be the same as or longer than the length of the middle core portion 4 along the second direction D2. The length of each of the side core portions 5 and 6 along the third direction D3 may be shorter or longer than the length of the middle core portion 4 along the third direction D3. The length of each of the side core portions 5 and 6 along the third direction D3 is shorter than the length of the winding portion 20 along the third direction D3. The length of each of the side core portions 5 and 6 along the third direction D3 may be longer than or equivalent to the length of the winding portion 20 along the third direction D3. The two side core portions 5 and 6 may have mutually different shapes and dimensions.

### (End Core Portions)

There are no particular limitations on the shapes of the end core portions 7 and 8, as long as they connect the end portions of the one middle core portion 4 and the two side core portions 5 and 6 to each other. In the present embodiment, the end core portions 7 and 8 are each shaped as a rectangular parallelepiped that is elongated in the second direction D2.

In the present embodiment, the two end core portions 7 and 8 have the same shape and dimensions as each other. The length of each of the end core portions 7 and 8 along the first direction D1 is substantially the same as the length of each of the side core portions 5 and 6 along the second direction D2. The length of each of the end core portions 7 and 8 along the third direction D3 is the same as the length of the middle core portion 4 and the side core portions 5 and 6 along the third direction D3. The two end core portions 7 and 8 may have mutually different shapes and dimensions.

### [Shapes of First Core Piece and Second Core Piece]

As shown in FIG. 1, the first core piece 31 and the second core piece 32 are divided pieces according to which the magnetic core 3 is divided into portions separated in the first direction D1. The first core piece 31 and the second core piece 32 of the present embodiment are E-shaped members that have the same shape as each other. The first core piece 31 and the second core piece 32 of the present embodiment also have the same dimensions as each other. The position where the first core piece 31 and the second core piece 32 are divided is the central portion of the magnetic core 3 in the first direction D1. Since the first core piece 31 and the second core piece 32 have the same shape, they can be produced using molds that have the same shape. The first core piece 31 and the second core piece 32 may have mutually different shapes and dimensions.

The first core piece 31 includes the end core portion 7, the first middle core portion 41, and the two first side core portions 51 and 61. The second core piece 32 includes the end core portion 8, the second middle core portion 42, and the two second side core portions 52 and 62.

The first middle core portion 41 and the second middle core portion 42 are each a portion of the middle core portion 4. The first middle core portion 41 and the second middle core portion 42 have the same length along the first direction D1. A gap is provided between the first middle core portion 41 and the second middle core portion 42. The elastic body 10, which will be described later, is provided in this gap.

The first side core portion 51 and the second side core portion 52 are each a portion of the side core portion 5. The first side core portion 51 and the second side core portion 52 have the same length along the first direction D1. No gap is provided between the first side core portion 51 and the second side core portion 52. The first side core portion 51 and the second side core portion 52 are continuous with each other due to being in direct contact with each other. Due to the first side core portion 51 and the second side core portion 52 being in direct contact with each other, the side core portion 5 is continuous and unseparated.

The first side core portion 61 and the second side core portion 62 are each a portion of the side core portion 6. The first side core portion 61 and the second side core portion 62 have the same length along the first direction D1. No gap is provided between the first side core portion 61 and the second side core portion 62. The first side core portion 61 and the second side core portion 62 are continuous with each other due to being in direct contact with each other. Due to the first side core portion 61 and the second side core portion 62 being in direct contact with each other, the side core portion 6 is continuous and unseparated.

### [Constituent Materials]

At least either the first core piece 31 or the second core piece 32 is constituted by a composite material molded body. The composite material molded body is formed by dispersing a soft magnetic powder in a resin. The composite material molded body is obtained by filling a mold with a raw material, in which a soft magnetic powder is mixed with and dispersed in an unsolidified resin, and then allowing the resin to solidify. By adjusting the content of the soft magnetic powder in the resin, it is possible to easily control magnetic characteristics such as the relative magnetic permeability and the saturation magnetic flux density of the composite material. In particular, the content ratio of the soft magnetic powder in the composite material can be easily adjusted to a low ratio, and the relative magnetic permeability can be easily reduced. Furthermore, a composite material can be more easily formed into a complicated shape than a powder compact, which will be described later. The content of the soft magnetic powder in the composite material molded body is 20% by volume or more and 80% by volume or less when the composite material is 100% by volume, for example. The content of the resin in the composite material molded body is 20% by volume or more and 80% by volume or less when the composite material is 100% by volume, for example.

A powder compact is obtained by compression-molding a powder made of a soft magnetic material, that is to say a soft magnetic powder. Compared to a composite material molded body, a powder compact can have a higher percentage of the soft magnetic powder in the core piece. Accordingly, with a powder compact, it is possible to easily improve magnetic characteristics such as the relative magnetic permeability and the saturation magnetic flux density. The content of the soft magnetic powder in the powder compact is over 80% by volume, or furthermore 85% by volume or more, when the powder compact is 100% by volume, for example.

A soft magnetic powder is an aggregate of soft magnetic particles. The soft magnetic particles are made of a soft magnetic material. Examples of a soft magnetic material include metals such as iron and an iron alloy, and non-metals such as ferrite. Examples of iron alloys include Fe—Si alloy and Fe—Ni alloy. The soft magnetic particles may be coated particles, which are soft magnetic particles whose surfaces are coated with an insulating coating. The insulating coating is made of phosphate, for example. The resin of the composite material is a thermosetting resin or a thermoplastic resin, for example. Examples of thermosetting resins include epoxy resin, phenol resin, silicone resin, and urethane resin. Examples of thermoplastic resins include polyphenylene sulfide (PPS) resin, polyamide (PA) resin (e.g., nylon 6, nylon 66, or nylon 9T), liquid crystal polymer (LCP), polyimide (PI) resin, and fluororesin. The composite material may contain a filler in addition to the resin. Adding a filler makes it possible to improve the heat dissipation of the composite material. The filler is a powder made of a non-magnetic material such as a ceramic or carbon nanotubes, for example. Examples of ceramics include metallic and non-metallic oxides, nitrides, and carbides. Examples of oxides include alumina, silica, and magnesium oxide. Examples of nitrides include silicon nitride, aluminum nitride, and boron nitride. One example of a carbide is silicon carbide.

Both the first core piece 31 and the second core piece 32 may be constituted by a composite material molded body. In this case, the first core piece 31 and the second core piece 32 may be constituted by the same type of composite material molded body, or may be constituted by composite material molded bodies that contain different amounts of soft magnetic powder. A configuration is possible in which either the first core piece 31 or the second core piece 32 is constituted by a composite material molded body, and the other one is constituted by a powder compact.

### «Molded Resin Portion»

The molded resin portion 9 covers at least part of the magnetic core 3, as shown in FIG. 1. The molded resin portion 9 has a function of protecting the magnetic core 3 from the external environment. The molded resin portion 9 may cover the coil 2 as well. If a portion of the molded resin portion 9 is interposed between the coil 2 and the magnetic core 3, insulation can be easily ensured between the coil 2 and the magnetic core 3. If the molded resin portion 9 extends across the coil 2 and the magnetic core 3, the coil 2 and the magnetic core 3 can be easily positioned relative to each other. Moreover, if the molded resin portion 9 extends across the first core piece 31 and the second core piece 32, the first core piece 31 and the second core piece 32 can be fixed to each other.

The molded resin portion 9 of the present embodiment surrounds an assembly of the coil 2, the magnetic core 3, and the later-described elastic body 10. The assembly of the present embodiment is protected from the external environment by the molded resin portion 9. Also, the assembly of the present embodiment is configured by integrating the coil 2, the magnetic core 3, and the elastic body 10 with use of the molded resin portion 9. At least part of the outer peripheral surface of the magnetic core 3 or at least part of the outer peripheral surface of the coil 2 may be exposed from the molded resin portion 9. The molded resin portion 9 of the present embodiment is interposed between the inner surface of the winding portion 20 and the middle core portion 4.

The resin forming the molded resin portion 9 is the same resin as the resin of the composite material described above, for example. The molded resin portion 9 may contain the filler described above, similarly to the composite material.

### «Elastic Body»

The elastic body 10 is provided so as to divide the middle core portion 4 at an intermediate point, as shown in FIG. 1. The elastic body 10 has a function of maintaining a predetermined inductance. Also, the elastic body 10 has a function of absorbing a load applied to the middle core portion 4 during the process for manufacturing the reactor 1. Although details of this will be described later, when forming the molded resin portion 9 in the process for manufacturing the reactor 1, pressure acts in a direction according to which the two end core portions 7 and 8 approach each other. A load is likely to be applied to the middle core portion 4 due to such pressure. By absorbing this load, the elastic body 10 suppresses the formation of cracks in the magnetic core 3. The elastic body 10 is arranged facing a region that includes the central portion of the end faces of the middle core portion 4.

A first area ratio of the elastic body 10 in the compressed state is 70% or more, for example. The first area ratio is the ratio of the area of the elastic body 10 to a predetermined area. The predetermined area is obtained by multiplying a length A and a length B shown in FIG. 3, that is to say length A x length B. The length A is the length of the middle core portion 4 along the third direction D3. In the present embodiment, the length of the middle core portion 4 along the third direction D3 is the same as the length of each of the end core portions 7 and 8 along the third direction D3. The length B is the distance between the inner faces of the two side core portions 5 and 6. Here, “between the inner faces of the two side core portions 5 and 6” means between the opposing faces of the two side core portions 5 and 6. The predetermined area is the area of a region that is likely to be subjected to pressure applied when forming the molded resin portion 9 in the process for manufacturing the reactor 1. The area of the elastic body 10 is the area of the face of the compressed elastic body 10 that faces the middle core portion 4. The predetermined area is the area of the portion indicated by diagonal hatching extending downward to the left in the lower portion of FIG. 3. The area of the elastic body 10 is the area of the portion indicated by diagonal hatching extending downward to the right in the lower portion of FIG. 3.

When the first area ratio in the compressed state is 70% or more, the elastic body 10 is provided in a certain range of the predetermined area. When the elastic body 10 is provided in a certain range where the aforementioned pressure is applied, the load applied to the middle core portion 4 is likely to be absorbed by the elastic body 10 in the process for manufacturing the reactor 1, and cracks are even more unlikely to be formed in the magnetic core 3. Since cracks are even more unlikely to be formed in the magnetic core 3 during the process for manufacturing the reactor 1, the reactor 1 having fewer cracks in the magnetic core 3 can be obtained. The larger the first area ratio is, the more likely it is for the elastic body 10 to absorb the load. However, if the first area ratio is too large, the elastic body 10 reaches the inner peripheral surface of the winding portion 20. If the elastic body 10 reaches the inner peripheral surface of the winding portion 20, the gap between the middle core portion 4 and the winding portion 20 is divided in the axial direction of the winding portion 20 by the portion of the elastic body 10 interposed therebetween. As a result, there is concern of the elastic body 10 impeding the flow of the unsolidified constituent resin of the molded resin portion 9. Also, if the elastic body 10 reaches the inner peripheral surface of the winding portion 20, the elastic body 10 spreads outward from the middle core portion 4 in the axial direction of the middle core portion 4, and the elastic body 10 may become damaged at the corner portions of the middle core portion 4. Also, if the elastic body 10 reaches the inner peripheral surface of the winding portion 20, when the unsolidified constituent resin of the molded resin portion 9 flows between the winding portion 20 and the middle core portion 4, there is concern of breakage of the elastic body 10 due to being pulled by the flow of the constituent resin. Therefore, it is preferable that the first area ratio is 95% or less. The first area ratio is preferably 70% or more and 95% or less, and more preferably 75% or more and 90% or less, or 80% or more and 85% or less.

A second area ratio of the elastic body 10 in the compressed state is 70% or more, for example. The second area ratio is the ratio of the area of elastic body 10 to the cross-sectional area of middle core portion 4. The cross-sectional area of the middle core portion 4 is the area of a cross section of the middle core portion 4 taken along a direction orthogonal to the lengthwise direction of the middle core portion 4. The area of the elastic body 10 is the area of the face of the compressed elastic body 10 that faces the middle core portion 4. The cross-sectional area of the middle core portion 4 is the area of the portion indicated by diagonal hatching extending downward to the left in the lower portion of FIG. 4. The area of the elastic body 10 is the area of the portion indicated by diagonal hatching extending downward to the right in the lower portion of FIG. 4.

If the second area ratio in the compressed state is 70% or more, the elastic body 10 is provided in a certain range of the cross-sectional area of the middle core portion 4. When the elastic body 10 is provided in a certain range of the cross-sectional area of the middle core portion 4, the load applied to the middle core portion 4 is likely to be absorbed by the elastic body 10 in the process for manufacturing the reactor 1, and cracks are even more unlikely to be formed in the magnetic core 3. Since cracks are even more unlikely to be formed in the magnetic core 3 during the process for manufacturing the reactor 1, the reactor 1 having fewer cracks in the magnetic core 3 can be obtained. The larger the second area ratio is, the more likely it is for the elastic body 10 to absorb the load. The elastic body 10 in the compressed state protrudes slightly from the middle core portion 4, for example. In this case, the second area ratio is greater than 100%. When the second area ratio is more than 100%, the compressed elastic body 10 extends over the entirety of the cross section of the middle core portion 4 in the process for manufacturing the reactor 1, and the load is likely to be absorbed by the elastic body 10. If the second area ratio is too large, it becomes difficult for the constituent resin of the molded resin portion 9 to flow during the process for manufacturing the reactor 1. Therefore, it is preferable that the second area ratio is 110% or less. The second area ratio is preferably 70% or more and 110% or less, and more preferably 80% or more and 110% or less, or 80% or more and 100% or less. If the second area ratio is less than 100%, the constituent resin of the molded resin portion 9 exists around the elastic body 10. In this case, the gap member is constituted by the elastic body 10 and the constituent resin of the molded resin portion 9.

The thickness of the elastic body 10 in the compressed state can be appropriately selected so as to maintain a desired inductance. The thickness of the elastic body 10 is 0.2 mm or more and 2.0 mm or less, furthermore 0.3 mm or more and 2.0 mm or less, and particularly 0.3 mm or more and 1.5 mm or less, for example.

It is preferable that the elastic body 10 has heat resistance to the extent that it is not melted or deformed by the unsolidified constituent resin of the molded resin portion 9 during formation of the molded resin portion 9. For example, the heat resistance temperature of the elastic body 10 is 150° C. or higher. It is preferable that the elastic body 10 has elasticity to the extent that it can be compressed by the pressure applied when forming the molded resin portion 9. For example, the Young's modulus of the elastic body 10 is 1 MPa or more and 100 MPa or less. It is preferable that the elastic body 10 has excellent thermal conductivity. For example, the thermal conductivity of the elastic body 10 is 0.8 W/m·K or more. The elastic body 10 is a non-magnetic body, for example. For example, the elastic body 10 is an insulator. The elastic body 10 is made of silicone rubber or butyl rubber, for example. The elastic body 10 may be a sheet made of polytetrafluoroethylene (PTFE) resin.

### «Other Matter»

Although not shown, the reactor 1 may include a holding member or an adhesive layer. The holding member is arranged between the coil 2 and the magnetic core 3 and has a function of ensuring electrical insulation between the coil 2 and the magnetic core 3. The holding member also has a function of defining the positions of the coil 2 and the magnetic core 3 relative to each other, and holding the positioned state. The holding member is arranged between the end faces of the winding portion 20 and the end core portions 7 and 8, for example. The holding member is arranged between the inner peripheral surface of the winding portion 20 and the outer peripheral surface of the middle core portion 4, for example. The portion of the holding member arranged between the inner peripheral surface of the winding portion 20 and the outer peripheral surface of the middle core portion 4 is structured so as to allow the unsolidified constituent resin of the molded resin portion 9 to flow between the winding portion 20 and the middle core portion 4. The adhesive layer fixes the assembly of the coil 2, the magnetic core 3, and the elastic body 10 to the installation surface.

### «Reactor Manufacturing Method»

A reactor manufacturing method will be described below with reference to FIGS. 5 to 7. The reactor manufacturing method includes a preparation step and a molding step.

[Preparation Step]In the preparation step, as shown in FIG. 5, an assembly of a coil 2, a magnetic core 3, and an elastic body 10α is prepared.

The coil 2 includes one winding portion 20. This coil 2 is similar to the coil 2 in the reactor 1 that is to be obtained. The coil 2 shown in FIG. 5 and the coil 2 shown in FIG. 1 are the same.

The magnetic core 3 includes a first core piece 31 and a second core piece 32 that are combined with each other. The magnetic core 3 is overall shaped as the character “θ” when the first core piece 31 and the second core piece 32 are combined with each other. The first core piece 31 and the second core piece 32 are similar to the first core piece 31 and the second core piece 32 in the reactor 1 that is to be obtained. The shapes of the first core piece 31 and the second core piece 32 shown in FIG. 5 are the same as the shapes of the first core piece 31 and the second core piece 32 shown in FIG. 1. When the first core piece 31 and the second core piece 32 are combined with each other, the magnetic core 3 includes a middle core portion 4, two side core portions 5 and 6, and two end core portions 7 and 8. The middle core portion 4 has a portion arranged inside the winding portion 20. The two side core portions 5 and 6 are arranged side by side with the middle core portion 4 on outward sides of the winding portion 20. The two end core portions 7 and 8 are arranged so as to connect the middle core portion 4 to the two side core portions 5 and 6 on outward sides of the end portions of the winding portion 20. At least either the first core piece 31 or the second core piece 32 is constituted by a composite material molded body.

In the magnetic core 3 during the manufacturing process, an elastic body 10α, which will be described later, is provided between a first middle core portion 41 and a second middle core portion 42. In other words, during the manufacturing process, the middle core portion 4 is divided at an intermediate point by the elastic body 10α. A thickness W2 of the elastic body 10α (FIG. 6) is thicker than a thickness W1 of the elastic body 10 (FIG. 3) of the reactor 1 shown in FIG. 1. Accordingly, the gap between the first middle core portion 41 and the second middle core portion 42 during the manufacturing process is larger than the gap between the first middle core portion 41 and the second middle core portion 42 in reactor 1 that is to be obtained. A gap 15 is formed between the first side core portion 51 and the second side core portion 52 in the magnetic core 3 during the manufacturing process. Similarly, a gap 15 is formed between the first side core portion 61 and the second side core portion 62 in the magnetic core 3 during the manufacturing process.

The first area ratio of the elastic body 10α in the uncompressed state is 45% or more, for example. The first area ratio is the ratio of the area of the elastic body 10α to a predetermined area. The predetermined area is obtained by multiplying a length A and a length B shown in FIG. 6, that is to say length A×length B. The predetermined area shown in FIG. 6 is the same as the predetermined area shown in FIG. 4. The area of the elastic body 10α is the area of the face of the elastic body 10α that faces the middle core portion 4 in a non-compressed state, that is to say before compression. The predetermined area is the area of the portion indicated by diagonal hatching extending downward to the left in the lower portion of FIG. 6. The area of the elastic body 10α is the area of the portion indicated by diagonal hatching extending downward to the right in the lower portion of FIG. 6.

The predetermined area is the area of a region that is likely to be subjected to pressure applied when forming the molded resin portion 9 in the process for manufacturing the reactor 1. When the first area ratio before compression is 45% or more, the uncompressed elastic body 10α is provided in a certain range of the predetermined area. When the uncompressed elastic body 10α is provided in a certain range where the pressure is applied, the load applied to the middle core portion 4 is likely to be absorbed by the elastic body 10α during the process for manufacturing the reactor 1, and cracks are even more unlikely to be formed in the magnetic core 3. The larger the first area ratio is, the more likely it is for the elastic body 10α to absorb the load. When subjected to the aforementioned load, the elastic body 10α becomes compressed and spreads radially outward from the center region of the middle core portion 4. If the first area ratio is too large, the elastic body 10α spreads until it reaches the inner peripheral surface of the winding portion 20. If the elastic body 10α reaches the inner peripheral surface of the winding portion 20, the gap between the middle core portion 4 and the winding portion 20 is divided in the axial direction of the winding portion 20 by the portion of the elastic body 10α interposed therebetween. As a result, there is concern of the elastic body 10α impeding the flow of the unsolidified constituent resin of the molded resin portion 9. It is preferable that the first area ratio is 80% or less. The first area ratio is preferably 45% or more and 80% or less, and more preferably 60% or more and 80% or less, or 70% or more and 80% or less.

The second area ratio of the elastic body 10α in the uncompressed state is 75% or more, for example. The second area ratio is the ratio of the area of the elastic body 10α to the cross-sectional area of the middle core portion 4. When the second area ratio before compression is 75% or more, the elastic body 10α is provided in a certain range of the cross-sectional area of the middle core portion 4. When the elastic body 10α is provided in a certain range of the cross-sectional area of the middle core portion 4, the load applied to the middle core portion 4 is likely to be absorbed by the elastic body 10α in the process for manufacturing the reactor 1, and cracks are even more unlikely to be formed in the magnetic core 3. The larger the second area ratio is, the more likely it is for the elastic body 10α to absorb the load. When subjected to the aforementioned load, the elastic body 10α becomes compressed and spreads radially outward from the center region of the middle core portion 4. If the second area ratio is too large, the elastic body 10α spreads until it reaches the inner peripheral surface of the winding portion 20. If the elastic body 10α reaches the inner peripheral surface of the winding portion 20, the gap between the middle core portion 4 and the winding portion 20 is divided in the axial direction of the winding portion 20 by the portion of the elastic body 10α interposed therebetween. As a result, there is concern of the elastic body 10α impeding the flow of the unsolidified constituent resin of the molded resin portion 9. Therefore, it is preferable that the second area ratio is 95% or less, as shown in FIG. 7. The second area ratio is preferably 75% or more and 95% or less, and more preferably 80% or more and 95% or less, or 85% or more and 95% or less.

The thickness of the elastic body 10α in the uncompressed state can be appropriately selected such that the elastic body 10α can absorb the load when compressed due to the molding step described later, and such that a desired inductance can be maintained by the compressed elastic body 10α. The thickness of the elastic body 10α is 0.2 mm or more and 2.0 mm or less, furthermore 0.3 mm or more and 1.9 mm or less, and particularly 0.3 mm or more and 1.4 mm or less, for example.

### [Molding Step]

In the molding step, as shown in FIG. 5, the assembly is placed in a mold 100, and a resin is injected into the mold 100 to form the molded resin portion 9 (FIG. 1) so as to cover at least part of the magnetic core 3. The injection of the resin is performed by applying a pressure of 15 MPa or more in a direction according to which the two end core portions 7 and 8 approach each other, that is to say in the direction of the white arrows shown in FIG. 5. This pressure is injection pressure when injecting the resin. After filling the mold with the resin, the assembly is sometimes held under a certain pressure such that the resin does not flow back through the gate. The holding pressure at this time may also be 15 MPa or higher.

Due to this pressure, the first core piece 31 and the second core piece 32 approach each other, and the elastic body 10α becomes compressed. Also, due to the above-described pressure, the first core piece 31 and the second core piece 32 approach each other, the first side core portion 51 and the second side core portion 52 come into direct contact with each other, and the first side core portion 61 and the second side core portion 62 come into direct contact with each other. In other words, the gap 15 shown in FIG. 5 disappears. By allowing the resin to solidify in this state, the reactor 1 shown in FIG. 1 is obtained.

With the reactor manufacturing method of the first embodiment, even if a high pressure of 15 MPa or more is applied when forming the molded resin portion 9, cracks are unlikely to be formed in the magnetic core 3. When the assembly of the coil 2, the magnetic core 3, and the elastic body 10α is placed in the mold 100, and resin is injected into the mold 100 to form the molded resin portion 9, pressure is applied in a direction according to which the two end core portions 7 and 8 approach each other. In the reactor manufacturing method of the first embodiment, the elastic body 10α is provided at an intermediate point in the middle core portion 4 that is likely to be influenced by the above-described pressure, and therefore the load applied due to the pressure can be absorbed by the elastic body 10α, and cracks are unlikely to be formed in the magnetic core 3. Since cracks are unlikely to be formed in the magnetic core 3 in the manufacturing process, few cracks are formed in the magnetic core 3 of the obtained reactor 1 of the first embodiment.

### Second Embodiment

A reactor 1 according to a second embodiment will be described below with reference to FIG. 8. The reactor 1 of the second embodiment is different from the reactor 1 of the first embodiment with respect to the shapes of the first core piece 31 and the second core piece 32 that constitute the magnetic core 3. The following description focuses on differences from the first embodiment described above, and descriptions will not be given for matter that is similar.

The first core piece 31 of the present embodiment includes an end core portion 7, a first middle core portion 41, and two side core portions 5 and 6. The first middle core portion 41 is a portion of the middle core portion 4. The length of the first middle core portion 41 along the first direction D1 is shorter than the length of the two side core portions 5 and 6 along the first direction D1. Accordingly, the first core piece 31 of the present embodiment is an E-shaped member in which the length of the first middle core portion 41 is shorter than the length of the two side core portions 5 and 6. The second core piece 32 of the present embodiment includes an end core portion 8 and a second middle core portion 42. The second middle core portion 42 is the remaining portion of the middle core portion 4. The second core piece 32 of the present embodiment is a T-shaped member. The magnetic core 3 is overall shaped as the character “θ” when the E-shaped first core piece 31 and the T-shaped second core piece 32 are combined with each other. An elastic body 10 is provided between the first middle core portion 41 and the second middle core portion 42. In other words, the middle core portion 4 of the present embodiment is divided at an intermediate point by the elastic body 10. The two side core portions 5 and 6 are each in direct contact with the end core portion 8 so as to obtain a continuous and unseparated configuration.

In the reactor 1 of the second embodiment as well, similarly to the first embodiment, due to the elastic body 10 being provided at an intermediate point in the middle core portion 4, pressure applied during the process for manufacturing the reactor 1 can be absorbed by the elastic body 10, and cracks are unlikely to be formed in the magnetic core 3.

### Third Embodiment

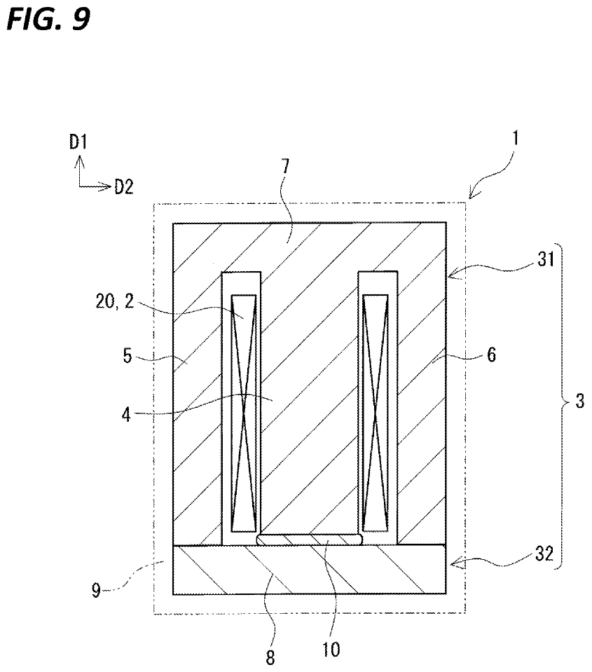

A reactor 1 according to a third embodiment will be described below with reference to FIG. 9. The reactor 1 of the third embodiment is different from the reactor 1 of the first embodiment with respect to the shapes of the first core piece 31 and the second core piece 32 that constitute the magnetic core 3. The following description focuses on differences from the first embodiment described above, and descriptions will not be given for matter that is similar.

The first core piece 31 of the present embodiment includes an end core portion 7, a middle core portion 4, and two side core portions 5 and 6. The first core piece 31 of the present embodiment is an E-shaped member. The second core piece 32 of the present embodiment includes an end core portion 8. The second core piece 32 of the present embodiment is an I-shaped member. The magnetic core 3 is overall shaped as the character “θ” when the E-shaped first core piece 31 and the I-shaped second core piece 32 are combined with each other. An elastic body 10 is provided between the middle core portion 4 and the end core portion 8. In other words, in the present embodiment, the boundary between the middle core portion 4 and the end core portion 8 is divided by the elastic body 10. The two side core portions 5 and 6 are each in direct contact with the end core portion 8 so as to obtain a continuous and unseparated configuration.

In the reactor 1 of the third embodiment as well, similarly to the first embodiment, due to the elastic body 10 being provided at an end portion of the middle core portion 4, pressure applied during the process for manufacturing the reactor 1 can be absorbed by the elastic body 10, and cracks are unlikely to be formed in the magnetic core 3.

### Fourth Embodiment

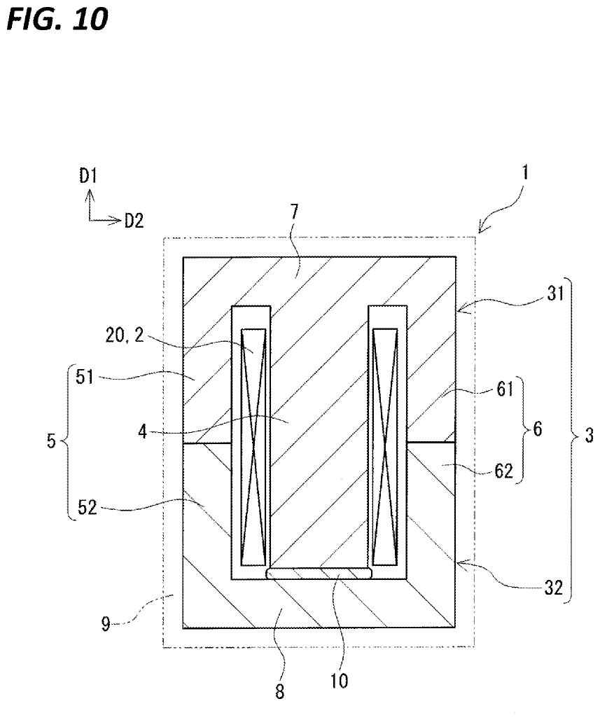

A reactor 1 according to a fourth embodiment will be described below with reference to FIG. 10. The reactor 1 of the fourth embodiment is different from the reactor 1 of the first embodiment with respect to the shapes of the first core piece 31 and the second core piece 32 that constitute the magnetic core 3. The following description focuses on differences from the first embodiment described above, and descriptions will not be given for matter that is similar.

The first core piece 31 of the present embodiment includes an end core portion 7, a middle core portion 4, and two first side core portions 51 and 61. The first side core portion 51 is a portion of the side core portion 5. The first side core portion 61 is a portion of the side core portion 6. The length of the middle core portion 4 along the first direction D1 is longer than the length of the two first side core portions 51 and 61 along the first direction D1. Accordingly, the first core piece 31 of the present embodiment is an E-shaped member in which the length of the first middle core portion 4 is longer than the length of the two first side core portions 51 and 61. The second core piece 32 of the present embodiment includes an end core portion 8 and two second side core portions 52 and 62. The second side core portion 52 is the remaining portion of the side core portion 5. The second side core portion 62 is the remaining portion of the side core portion 6. The second core piece 32 of the present embodiment is a U-shaped member. The magnetic core 3 is overall shaped as the character “θ” when the E-shaped first core piece 31 and the U-shaped second core piece 32 are combined with each other. An elastic body 10 is provided between the middle core portion 4 and the end core portion 8. In other words, in the present embodiment, the boundary between the middle core portion 4 and the end core portion 8 is divided by the elastic body 10. The first side core portion 51 and the second side core portion 52 are in direct contact with each other so as to be continuous and unseparated. The first side core portion 61 and the second side core portion 62 are in direct contact with each other so as to be continuous and unseparated. The end core portion 7 and the middle core portion 4 are integrally molded to form a single body.

In the reactor 1 of the fourth embodiment as well, similarly to the first embodiment, due to the elastic body 10 being provided at an end portion of the middle core portion 4, pressure applied during the process for manufacturing the reactor 1 can be absorbed by the elastic body 10, and cracks are unlikely to be formed in the magnetic core 3.

### Fifth Embodiment

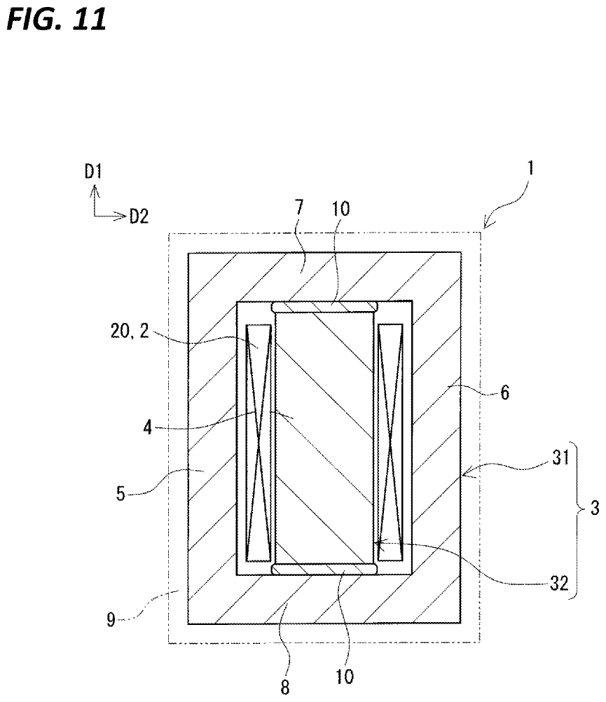

A reactor 1 according to a fifth embodiment will be described below with reference to FIG. 11. The reactor 1 of the fifth embodiment is different from the reactor 1 of the first embodiment with respect to the shapes of the first core piece 31 and the second core piece 32 that constitute the magnetic core 3. The following description focuses on differences from the first embodiment described above, and descriptions will not be given for matter that is similar.

The first core piece 31 of the present embodiment includes two end core portions 7 and 8 and two side core portions 5 and 6. The two end core portions 7 and 8 and the two side core portions 5 and 6 are integrally molded bodies that constitute a single body. The first core piece 31 of the present embodiment is an O-shaped member. The second core piece 32 of the present embodiment includes the middle core portion 4. The second core piece 32 of the present embodiment is an I-shaped member. The magnetic core 3 is overall shaped as the character “θ” when the O-shaped first core piece 31 and the I-shaped second core piece 32 are combined with each other. An elastic body 10 is provided between the middle core portion 4 and the end core portion 7. In other words, in the present embodiment, the boundary between the middle core portion 4 and the end core portion 7 is divided by the elastic body 10. Similarly, another elastic body 10 is provided between the middle core portion 4 and the end core portion 8. In other words, in the present embodiment, the boundary between the middle core portion 4 and the end core portion 8 is divided by the other elastic body 10. In the present embodiment, elastic bodies 10 are provided so as to separate both boundaries between the middle core portion 4 and the end core portions 7 and 8. Alternatively, a configuration is possible in which an elastic body 10 is provided so as to separate only the boundary between the middle core portion 4 and the end core portion 7. In this case, at the boundary between the middle core portion 4 and the end core portion 8 where the elastic body 10 is not provided, the middle core portion 4 and the end core portion 8 are in direct contact with each other so as to be continuous and unseparated.

In the reactor 1 of the fifth embodiment as well, similarly to the first embodiment, due to the elastic bodies 10 being provided at end portions of the middle core portion 4, pressure applied during the process for manufacturing the reactor 1 can be absorbed by the elastic bodies 10, and cracks are unlikely to be formed in the magnetic core 3.

### Sixth Embodiment

The reactors 1 according to the first to fifth embodiments can be used for applications that satisfy the following power conduction conditions. The power conduction conditions include, for example, that the maximum direct current is 100 A or more and 1000 A or less, the average voltage is 100 V or more and 1000 V or less, and the operating frequency is 5 kHz or more and 100 kHz or less. The reactors 1 according to the first to fifth embodiments can be typically used as a component of a converter mounted in a vehicle (typically an electric automobile or a hybrid vehicle) or the like, or a component of a power conversion device that includes the converter.

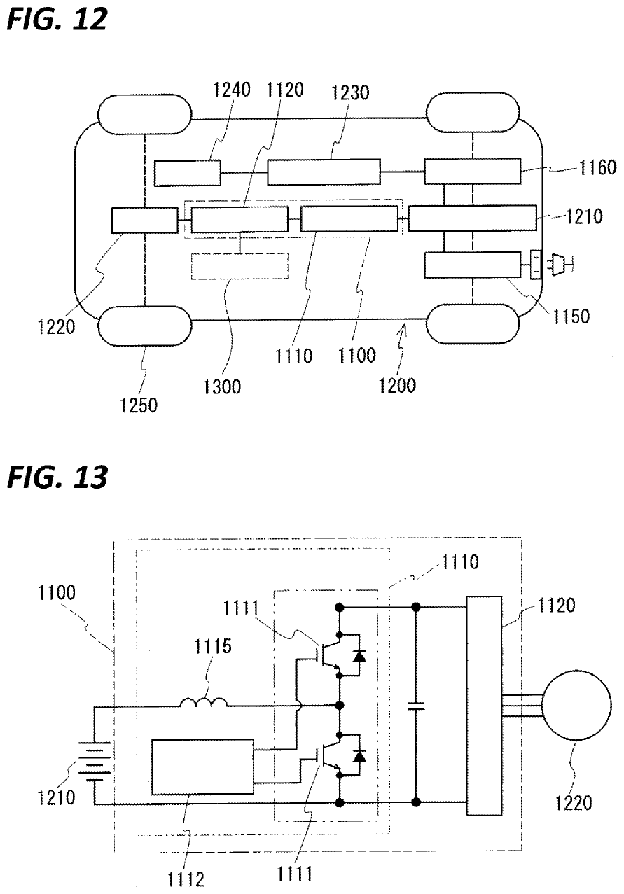

As shown in FIG. 12, a vehicle 1200 such as a hybrid vehicle or an electric automobile includes a main battery 1210, a power conversion device 1100 connected to the main battery 1210, and a motor 1220 that is used for traveling and is driven by power supplied from the main battery 1210. The motor 1220 is typically a three-phase AC motor that drives wheels 1250 during travel, and functions as a generator during regeneration. In the case of a hybrid vehicle, the vehicle 1200 includes an engine 1300 in addition to a motor 1220. The vehicle 1200 in FIG. 12 includes an inlet as a charging point, but may include a plug instead.

The power conversion device 1100 includes a converter 1110 connected to the main battery 1210, and an inverter 1120 that is connected to the converter 1110 and performs conversion between direct current and alternating current. During traveling of the vehicle 1200, the converter 1110 shown in the present embodiment steps up the input voltage (about 200 V to 300 V) from the main battery 1210 to about 400 V to 700 V, and supplies the boosted power to the inverter 1120. During regeneration, the converter 1110 steps down the input voltage output from the motor 1220 via the inverter 1120 to a DC voltage suitable for the main battery 1210, and charges the main battery 1210. The input voltage is DC voltage. During traveling of the vehicle 1200, the inverter 1120 converts the DC voltage boosted by the converter 1110 into a predetermined AC voltage and supplies the power to the motor 1220, whereas during regeneration, the inverter 1120 converts AC voltage output from the motor 1220 into DC voltage and outputs the power to the converter 1110.

As shown in FIG. 13, the converter 1110 includes a plurality of switching elements 1111, a drive circuit 1112 that controls the operation of the switching elements 1111, and a reactor 1115, and performs conversion of an input voltage by repeated ON/OFF operations. Here, the conversion of the input voltage is stepping up and stepping down. Power devices such as field effect transistors or insulated gate bipolar transistors are used as the switching elements 1111. The reactor 1115 utilizes the property of a coil that attempts to prevent a change in the current flowing in the circuit to achieve a function of smoothing a change in the current when the current attempts to increase or decrease due to the switching operation. The reactor 1 of any one of the first to fifth embodiments is provided as the reactor 1115. Due to including the reactor with the magnetic core that has few cracks, low loss can be expected for the power conversion device 1100 and the converter 1110.

In addition to the converter 1110, the vehicle 1200 includes a power supply device converter 1150 connected to the main battery 1210, and an auxiliary power supply converter 1160 that is connected to a sub battery 1230 (power supply for accessories 1240) and the main battery 1210 and converts a high voltage from the main battery 1210 to a low voltage. The converter 1110 typically performs DC-DC conversion, whereas the power supply device converter 1150 and the auxiliary power supply converter 1160 typically perform AC-DC conversion. Some power supply device converters 1150 perform DC-DC conversion. The reactor of the power supply device converter 1150 and the auxiliary power supply converter 1160 has a configuration similar to that of the reactor 1 of any one of the first to fifth embodiments, and the size, shape, and the like of the reactor can be changed appropriately. Also, the reactor 1 of any one of the first to fifth embodiments can be used in a converter that performs conversion on input power but only performs stepping up or stepping down.

### LIST OF REFERENCE NUMERALS

1 reactor
2 coil, 20 winding portion
3 magnetic core, 31 first core piece, 32 second core piece
4 middle core portion
41 first middle core portion, 42 second middle core portion
5, 6 side core portion
51, 61 first side core portion, 52, 62 second side core portion
7, 8 end core portion
9 molded resin portion
10, 10α elastic body, 15 gap
100 mold
A, B length, W1, W2 thickness
D1 first direction, D2 second direction, D3 third direction
1100 power conversion device, 1110 converter, 1111 switching element
1112 drive circuit, 1115 reactor, 1120 inverter
1150 power supply device converter, 1160 auxiliary power supply converter
1200 vehicle, 1210 main battery, 1220 motor
1230 sub battery, 1240 accessory, 1250 wheel, 1300 engine

1. A reactor comprising:
a coil;
a magnetic core;
a molded resin portion; and
an elastic body,
wherein the coil includes one winding portion,
the magnetic core includes a first core piece and a second core piece combined with each other,
at least either the first core piece or the second core piece is constituted by a molded body of a composite material in which a soft magnetic powder is dispersed in a resin,
the magnetic core includes a middle core portion, two side core portions, and two end core portions, in a state where the first core piece and the second core piece are combined,
the middle core portion includes a portion arranged inside the winding portion,
the two side core portions are arranged side by side with the middle core portion on outward sides of the winding portion,
the two end core portions are arranged in such a manner as to connect the middle core portion to the two side core portions on outward sides of end portions of the winding portion,
the molded resin portion covers at least part of the magnetic core,
the elastic body is provided in such a manner as to divide the middle core portion at an intermediate point or divide at least one of boundaries between the middle core portion and the end core portions, and
a ratio of the area of the elastic body to a cross-sectional area of the middle core portion is over 100% and 110% or less,
the cross-sectional area of the middle core portion being the area of a cross-section of the middle core portion taken along a direction orthogonal to a lengthwise direction of the middle core portion, and
the area of the elastic body being the area of a region defined by an outer edge of the elastic body including a face of the elastic body facing the middle core portion when the elastic body is in a compressed state.

2. The reactor according to claim 1,
wherein the two side core portions and the two end core portions are continuous with each other.

3. The reactor according to claim 1,
wherein a ratio of the area of the elastic body to a predetermined area is 70% or more,
the predetermined area being obtained by length A×length B,
the length A being the length of the middle core portion along a direction orthogonal to both a lengthwise direction of the middle core portion and a direction in which the middle core portion and the two side core portions are side by side,
the length B being a distance between inward faces of the two side core portions, and
the area of the elastic body being the area of a face of the elastic body facing the middle core portion when the elastic body is in a compressed state.

4. The reactor according to claim 1,
wherein the elastic body is made of silicone rubber or butyl rubber.

5. The reactor according to claim 1,
wherein the first core piece and the second core piece are each an E-shaped member including one of the two end core portions, a portion of the middle core portion, and a portion of each of the two side core portions.

6. The reactor according to claim 1,
wherein the first core piece is an E-shaped member including one of the two end core portions, a portion of the middle core portion, and each of the two side core portions, and
the second core piece is a T-shaped member including another one of the two end core portions, and a remaining portion of the middle core portion.

7. The reactor according to claim 1,
wherein the first core piece is an E-shaped member including one of the two end core portions, the middle core portion, and each of the two side core portions, and
the second core piece is an I-shaped member including another one of the two end core portions.

8. The reactor according to claim 1,
wherein the first core piece is an E-shaped member including one of the two end core portions, the middle core portion, and a portion of each of the two side core portions, and
the second core piece is a U-shaped member including another one of the two end core portions, and a remaining portion of each of the two side core portions.

9. The reactor according to claim 1,
wherein the first core piece is an O-shaped member including each of the two end core portions and each of the two side core portions, and
the second core piece is an I-shaped member including the middle core portion.

10. A converter comprising the reactor according to claim 1.

11. A power conversion device comprising the converter according to claim 10.

12. A reactor manufacturing method comprising the steps of:
preparing an assembly including a coil, a magnetic core, and an elastic body; and
forming a molded resin portion in such a manner as to cover at least part of the magnetic core, by arranging the assembly in a mold and injecting a resin into the mold,
wherein the coil includes one winding portion,
the magnetic core includes a first core piece and a second core piece combined with each other,
at least either the first core piece or the second core piece is constituted by a molded body of a composite material in which a soft magnetic powder is dispersed in a resin,
the magnetic core includes a middle core portion, two side core portions, and two end core portions, in a state where the first core piece and the second core piece are combined,
the middle core portion includes a portion arranged inside the winding portion,
the two side core portions are arranged side by side with the middle core portion on outward sides of the winding portion,
the two end core portions are arranged in such a manner as to connect the middle core portion to the two side core portions on outward sides of end portions of the winding portion,
in the preparing of the assembly, the elastic body is arranged in such a manner as to divide the middle core portion at an intermediate point or divide at least one of boundaries between the middle core portion and the end core portions, and
in the forming of the molded resin portion, a pressure of 15 MPa or more is applied in a direction according to which the two end core portions approach each other.

13. The reactor manufacturing method according to claim 12,
wherein in the preparing of the assembly, an elastic body in an uncompressed state is arranged, the elastic body in the uncompressed state having an area greater than or equal to 45% of a predetermined area,
the predetermined area being obtained by length A×length B,
the length A being the length of the middle core portion along a direction orthogonal to both a lengthwise direction of the middle core portion and a direction in which the middle core portion and the two side core portions are side by side, and
the length B being a distance between inward faces of the two side core portions.

14. The reactor manufacturing method according to claim 12,
wherein in the preparing of the assembly, an elastic body in an uncompressed state is arranged, the elastic body in the uncompressed state having an area greater than or equal to 75% and less than or equal to 95% of a cross-sectional area of the middle core portion,
the cross-sectional area of the middle core portion being the area of a cross-section of the middle core portion taken along a direction orthogonal to a lengthwise direction of the middle core portion.

15. (canceled)
